(19) United States
(12) Patent Application Publication
(10) Pub. No.: US 2005/0099064 A1
(43) Pub. Date: May 12, 2005

(54) Device for fixing coil assemblies of solenoid valves for electronically controlled brake system

(75) Inventor: Sang-Cheol Lee, Namyangju-City (KR)

Correspondence Address: Richard P. Berg;c/o LADAS & PARRY, Suite 2100, 5670 Wilshire Boulevard, Los Angeles, CA, 90036-5679, US

(73) Assignee: MANDO CORPORATION

(21) Appl. No.: 10/980,691

(22) Filed: Nov. 2, 2004

(30) Foreign Application Priority Data
Nov. 12, 2003 (KR) 2003-79938

(51) Int. Cl. B60T 8/36

(52) U.S. Cl. 303/119.3

(57) ABSTRACT

A device for fixing coil assemblies of solenoid valves for an electronically controlled brake system in which a bobbin of each coil assembly is firmly coupled to a housing of an electric control unit (ECU) by fixing bosses provided at the bottom of the bobbin and fixing grooves formed at the bottom of the ECU housing to receive the fixing bosses, and cases enclosing the bobbin are elastically supported by the elastic support member. Accordingly, the bobbin and cases can be firmly fixed to the ECU housing. Vertical movement of the cases is also restrained. Accordingly, magnetic flux passing through the cases is constant. A certain gap is also maintained between the bobbin and an upper one of the cases. Therefore, it is possible to prevent the resistance of the coil wound around the bobbin from being varied due to the weight of the upper case.

### CROSS-REFERENCE TO RELATED APPLICATION

This application claims the benefit of Korean Patent Application No. 2003-79938, filed on Nov. 12, 2003 in the Korean Intellectual Property Office, the disclosure of which is incorporated herein by reference.

### BACKGROUND OF THE INVENTION

1. Field of the Invention

The present invention relates to a solenoid valve for an electronically controlled brake system, and more particularly to a device for fixing coil assemblies of solenoid valves to a housing of an electric control unit (ECU) in an electronically controlled brake system.

2. Description of the Related Art

Generally, electronically controlled brake systems are used to efficiently prevent generation of a slippage phenomenon in a vehicle, and thus, to obtain a strong and stable brake force. For such electronically controlled brake systems, there are an anti-lock brake system (ABS) adapted to prevent slippage of wheels during a braking operation, a brake traction control system (BTCS) adapted to prevent slippage of drive wheels during quick start or sudden acceleration, and a vehicle dynamic control system (VDCS), which is a combination of the ABS and BTCS to stably maintain the running state of a vehicle by controlling the pressure of brake oil.

Such an electronically controlled brake system includes a plurality of solenoid valves to control the pressure of brake oil transmitted to wheel brakes of a vehicle, a low-pressure accumulator to temporarily store the brake oil, a pump to forcibly pump the brake oil temporarily stored in the low-pressure accumulator, a high-pressure accumulator to reduce pressure pulsation of the brake oil pumped by the pump, and an electric control unit (ECU) to electrically control the solenoid valves and pump.

Respective valve assemblies of the solenoid valves, accumulators, and pump are received in a compact state in a hydraulic block made of an aluminum material. The ECU is coupled with the hydraulic block by means of bolts. The ECU includes a housing, in which respective coil assemblies of the solenoid valves and a circuit board are received. Hereinafter, these structures will be described in detail.

Referring to FIG. 1, a conventional electronically controlled brake system is illustrated. As shown in FIG. 1, the electronically controlled brake system includes a hydraulic block 1, in which respective valve assemblies 2a of solenoid valves 2 are fitted in a compact state.

The electronically controlled brake system also includes a housing 3a injection-molded to have a rectangular box structure having a bottom wall and side walls while being opened at the top thereof, and coupled to the hydraulic block 1 by means of bolts 3c, and a circuit board 3b mounted in a space defined in a lower portion of the housing 3a. Respective coil assemblies 2b of the solenoid valves 2 are mounted in the housing 3a.

Each coil assembly 2b has a cylindrical body opened at the top and bottom thereof, and a coil 2c wound around the cylindrical body. Leads 2d extend from the coil 2c to connect the coil 2c to the circuit board 3b. When the ECU housing 3a is coupled to the hydraulic block 1, a sleeve-shaped lower portion of each valve assembly 2a is loosely received in a central portion of the associated coil assembly 2b. Accordingly, when current is applied to each coil assembly 2b, an electric field is generated around the coil assembly 2b, so that the valve assembly 2a of the associated solenoid valve 2 is operated to open or close the solenoid valve 2.

Each coil assembly 2b is fixed, at a lower end thereof, to the bottom of the ECU housing 3a by a fixing member 4 over-molded on the bottom of the ECU housing 3a around the lower end of the coil assembly 2b. That is, the coil assembly 2b is fixed to the bottom of the ECU housing 3a by a “molder” made of rubber. In this state, each of the valve assemblies 2a mounted to the hydraulic block 1 is coupled with the associated coil assembly 2b.

In the conventional electronically controlled brake system, however, there is a problem in that a great deal of time is required for the process of fixing the coil assemblies 2b of the solenoid valves 2 because the fixing of the coil assemblies 2b is achieved through a molding process using rubber. The fixing of each coil assembly 2b is achieved by positioning the coil assembly 2b at a desired position on the bottom of the ECU housing 3a, which is injection-molded using plastic, and then over-molding rubber on the bottom of the ECU housing 3a around the coil assembly 2b.

Since the fixing of each coil assembly 2b is achieved by molding rubber on the ECU housing 3a, as mentioned above, the coil assembly fixing process is difficult and requires a great deal of time. As a result, an increase in the manufacturing costs occurs.

### SUMMARY OF THE INVENTION

The present invention has been made in view of the above-mentioned problems, and an aspect of the invention is to provide a solenoid valve for an electronically controlled brake system which has an improved fixing structure for a coil assembly included in the solenoid valve to easily achieve the fixing of the coil assembly, and thus, to reduce the manufacturing costs of the electronically controlled brake system.

In accordance with one aspect, the present invention provides, in an electronically controlled brake system comprising an electric control unit (ECU) housing, and a plurality of solenoid valves each comprising a valve assembly including a sleeve and an armature slidably received in the sleeve, a coil assembly including a bobbin to axially receive the sleeve of the valve assembly and a coil wound around the bobbin, a case to receive the bobbin, the case being axially spaced from a top of the bobbin to define a predetermined gap, leads fixed to the bobbin in an inserted manner to be electrically connected to a circuit board arranged in the ECU housing, and a fixing device to fix the coil assembly to the ECU housing, the coil assemblies of the solenoid valves being arranged in the ECU housing while being uniformly spaced apart from one another, the fixing device comprising: fixing bosses axially protruded from a bottom of the bobbin to extend axially through the case; fixing grooves formed at a bottom wall of the ECU housing to receive protruded ends of the fixing bosses, and thus, to fix the fixing bosses, respectively; and an elastic support member provided at the bottom wall of the ECU housing to elastically support a bottom of the case.

The elastic support member may be fixed to the bottom wall of the ECU housing at one end, and may be free at the other end.

The elastic support member may be provided with a protrusion protruded from an upper surface of the free end of the elastic member to support the case.

The free end and the protrusion may have arc shapes to stably elastically support the bottom of the case, respectively.

The elastic support member may have a structure having a width gradually reduced toward the free end so that the elastic support member does not interfere with the fixing grooves.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a sectional view illustrating a solenoid valve mounting structure of a conventional electronically controlled brake system;

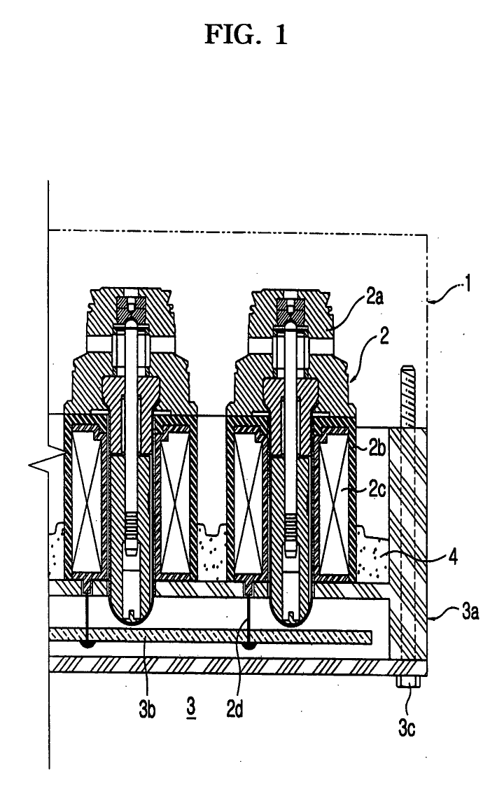

FIG. 2 is a perspective view illustrating an internal structure of an ECU housing in an electronically controlled brake system according to the present invention;

FIG. 3 is an exploded perspective view illustrating a part of a solenoid valve structure according to the present invention;

FIG. 4 is a sectional view illustrating a device for fixing coil assemblies of solenoid valves in accordance with the present invention; and

FIG. 5 is a sectional view illustrating the device for fixing the coil assemblies of the solenoid valves in accordance with the present invention, taken in a direction different from that of FIG. 4.

### DETAILED DESCRIPTION OF THE PREFERRED EMBODIMENTS

Reference will now be made in detail to the embodiments of the present invention, examples of which are illustrated in the accompanying drawings. The embodiments are described below to explain the present invention by referring to the figures.

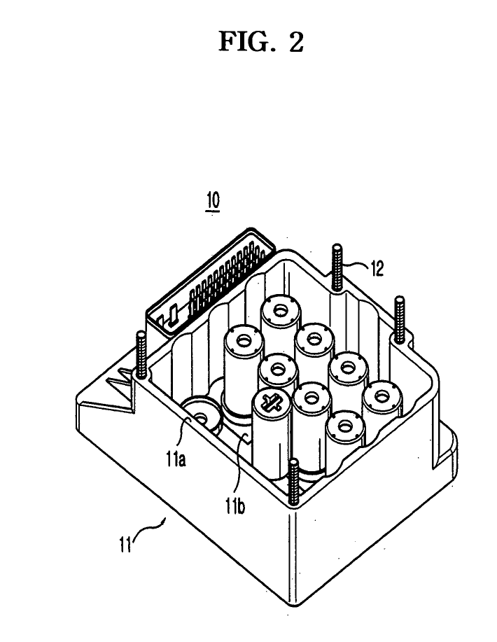

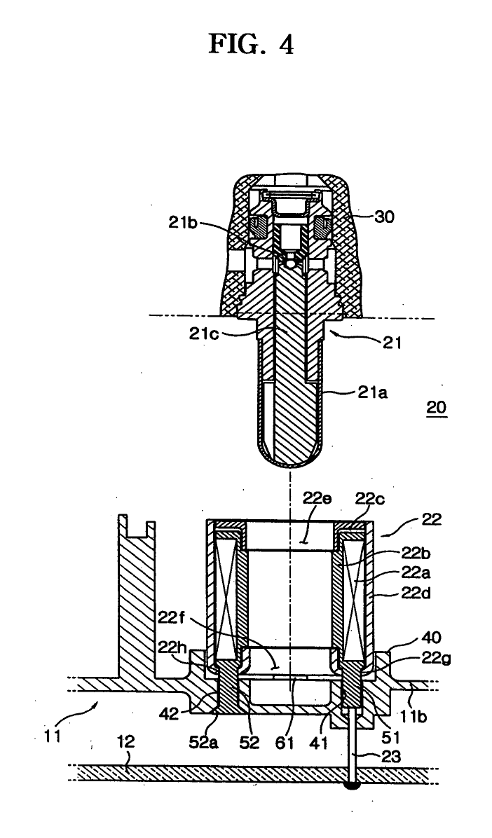

Referring to FIG. 2, an ECU 10, which is included in an electronically controlled brake system according to the present invention, is illustrated. As shown in FIG. 2, the ECU 10 includes an ECU housing 11 having side walls 11a and a bottom wall 11b while being opened at the top thereof, and a circuit board 12 (FIG. 4) mounted to an outer surface of the bottom wall 11b of the ECU housing 11. With this configuration, the ECU 10 controls the overall operation of the electronically controlled brake system.

A hydraulic block 30 (FIG. 4) is coupled to the top of the ECU housing 11 by means of mounting bolts 12. The hydraulic block 30 receives therein a plurality of normal open type or normal close type solenoid valves 20 (FIG. 4), a pair of pumps (not shown), and low-pressure and high-pressure accumulators (not shown) in a compact state.

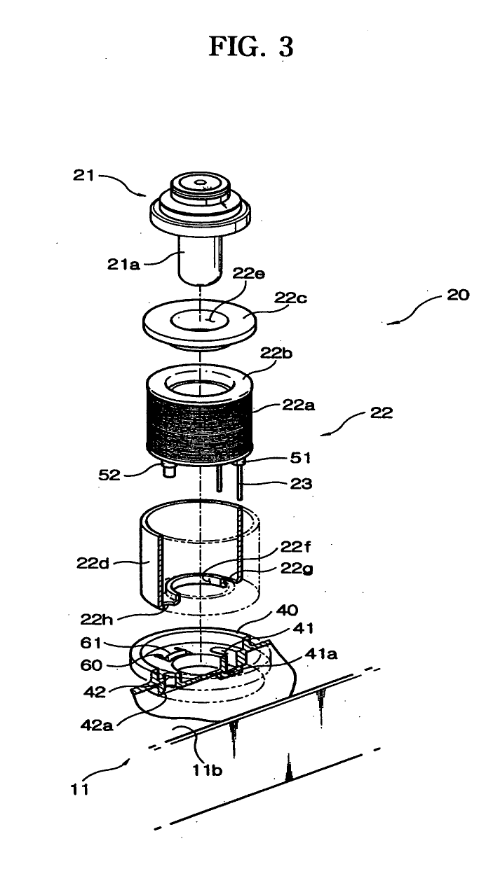

Referring to FIGS. 3 and 4, each solenoid valve 20 includes a valve assembly 21, and a coil assembly 22. For convenience of description, the following description will be given in conjunction with only one solenoid valve. The valve assembly 21 includes an orifice 21b, a sleeve 21a coupled to the coil assembly 22 such that the sleeve 21a is loosely received in the coil assembly 22, and an armature 21c slidably received in the sleeve 21a to open and close the orifice 21b. The coil assembly 22 generates an electromagnetic force when current is applied to the coil assembly 22, to actuate the armature 21c.

The valve assembly 21 is tightly fitted in the hydraulic block 30. The coil assembly 22 is mounted on the bottom wall 11 b of the ECU housing 11 such that the coil assembly 22 extends vertically. The valve assembly 21 is electrically connected to the circuit board 12 via leads 23, as will be described hereinafter.

The coil assembly 22 is firmly fixed to the hydraulic block 30 by a recess 40 formed at the bottom wall 11 b of the ECU housing 11 to receive the coil assembly 22, and a fixing device to fix the coil assembly 22 received in the recess 40. This configuration will be described in detail hereinafter.

The coil assembly 22 includes a cylindrical bobbin 22b, around which a coil 22a is wound several times. The leads 23 are also included in the coil assembly 22. The leads 23 are fixed to a lower end of the bobbin 22b in an inserted manner, and are connected with opposite ends of the coil 22a, respectively, to guide the supply of current to the coil 22a. The coil assembly 22 also includes an upper case 22c and a lower case 22d coupled to each other to enclose the bobbin 22b. The bobbin 22b is formed using a plastic material in accordance with an injection molding process. In this process, the leads 23 are fixed to the lower end of the bobbin 22b in an inserted manner such that the leads 23 extend downwardly from the bobbin 22b.

The lower case 22d has an upwardly-opened cylindrical structure. The upper case 22c is coupled to an opened upper end of the lower case 22d to cover the upper end of the lower case 22d in a state in which the bobbin 22d is received in the lower case 22d. A predetermined gap is maintained between the bobbin 22b and the upper case 22c in order to prevent the resistance of the coil 22a wound around the bobbin 22b from being varied due to the weight of the upper case 22c. Through holes 22e and 22f are formed at respective central portions of the bottoms of the upper and lower cases 22c and 22d so that the sleeve 21a of the valve assembly 21 extends through the upper and lower cases 22c and 22d. Holes 22g and 22h are formed through the bottom of the lower case 22d at opposite sides in a symmetrical manner so that first and second fixing bosses 51 and 52 extend through the holes 22g and 22h in a loose manner, respectively.

The recess 40 is defined by an upwardly-opened cylindrical structure formed on the bottom wall 11b of the ECU housing 11. The lower end of the coil assembly 22 is fitted in the recess 40. Thus, the coil assembly 22 is temporarily assembled to the ECU housing 11.

As described above, the fixing device is adapted to firmly fix the coil assembly 22 fitted in the recess 40. The first and second fixing bosses 51 and 52 are included in the fixing device. The first and second fixing bosses 51 and 52 are provided at the lower end of the bobbin 22b in a symmetrical manner. The fixing device also includes first and second fixing grooves 41 and 42 formed at an inner surface of the bottom of the recess 40 in the ECU housing 11 to engage with respective lower ends of the first and second fixing bosses 51 and 52, and an elastic support member 60 provided at the bottom of the recess 40 in the ECU housing 11 to elastically support the lower case 22d in the recess 40.

The first fixing boss 51 is formed on the lower end of the bobbin 22b at one side of the bobbin 22b in the form of an oval tubular member so that the leads 23 extend through the first fixing boss 51. The second fixing boss 52 is formed on the lower end of the bobbin 22b at the other side of the bobbin 22b in the form of a circular rod member such that the second fixing boss 52 opposes the first fixing boss 51. The first and second fixing bosses 51 and 52 are formed during a process of injection-molding the bobbin 22b such that the first and second fixing bosses 51 and 52 extend in an axial direction of the bobbin 22b while being integral with the bobbin 22b. The leads 23 to connect the coil 22a to the circuit board 12 are inserted into the first fixing boss 51. The second fixing boss 52 extends by a predetermined length so that the second fixing boss 52 is protruded through and beyond the second fixing groove 42. The protruded end of the second fixing boss 52 is subsequently plastically deformed to prevent the coil assembly 22 from being separated from the ECU housing 11.

The first fixing groove 41 is formed at the inner surface of the bottom of the recess 40 such that the first fixing groove 41 corresponds to the first fixing boss 51. Lead holes 41a are formed through the bottom of the first fixing groove 41 so that the leads 23 extend through the lead holes 41 a, respectively. The second fixing groove 42 is formed at the inner surface of the bottom of the recess 40 such that the second fixing groove 42 corresponds to the second fixing boss 52. A taper hole 42a is formed through the bottom of the second fixing groove 42. The taper hole 42a has a diameter gradually increased as the taper hole 42 extends downwardly. By virtue of such a structure of the taper hole 42a, a separation-preventing step 52 having a dish shape can be formed when the protruded end of the second fixing boss 52 is plastically deformed.

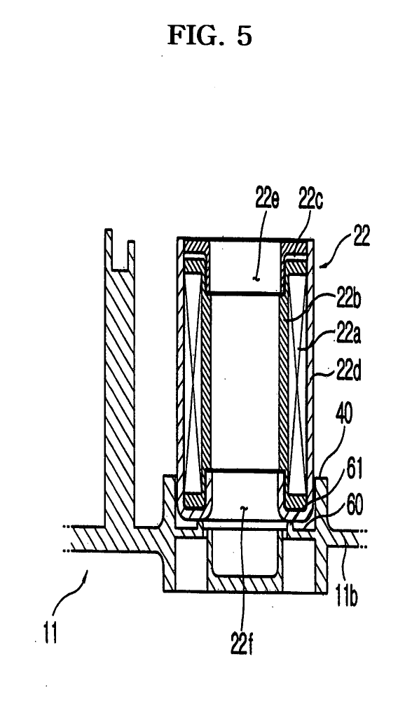

As shown in FIGS. 3 and 5, the elastic support member 60 has a rectangular plate shape. The elastic support member 60 is arranged at the bottom of the recess 40 inside the recess 40 to elastically support the bottom of the lower case 22d.

The elastic support member 60 is formed by cutting a bottom portion of the recess 40 such that the elastic support member 60 is fixed at one end thereof while being free at the other end. A protrusion 61 is provided at an upper surface of the free end of the elastic support member 60. The protrusion 61 comes into direct contact with the bottom of the lower case 22d when the lower case 22d is fitted in the recess 40. The free end of the elastic support member 60 and protrusion 61 have arc shapes, respectively. In accordance with these structures, the bottom of the lower case 22d is stably elastically supported.

Meanwhile, the elastic support member 50 may have a triangular structure having a width gradually reduced as the elastic support member 50 extends toward the free end thereof, in order to prevent the elastic support member 50 from interfering with the first and second fixing holes 41 and 42.

Now, the process for assembling the solenoid valve 20 having the above-described configuration according to the present invention will be described.

First, the bobbin 22b, around which the coil 22a is wound, is inserted into the lower case 22d such that the first and second fixing bosses 51 and 52 extend through and beyond the holes 22g and 22h, respectively. Thereafter, the upper case 22c is coupled to the upper end of the lower case 22d to cover the top of the lower case 22d. Thus, the coil assembly 22 is completely assembled.

Subsequently, the coil assembly 22 is seated in the recess 40, using an auxiliary tool, for example, a jig, such that the first and second fixing bosses 51 and 52 are inserted into the first and second fixing grooves 41 and 42, respectively.

Under the condition in which the coil assembly 22 is seated in the recess 40, the leads 23 inserted in the first fixing boss 51 extend into a space defined in the lower portion of the ECU housing 11 through the lead holes 41a of the first fixing groove 41. The leads 23 are then connected to the circuit board 12. The second fixing boss 52 also extends through the taper hole 42a of the second fixing groove 42 into the space defined in the lower portion of the ECU housing 11.

The protrusion 61 of the elastic support member 60 is also depressed by the coil assembly 22, so that the elastic support member 60 is elastically deformed to be downwardly inclined.

When heat is applied to the protruded end of the second fixing boss 52 in the above-described state, using an ultrasonic welding device or the like, the protruded end of the second fixing boss 52 is plastically deformed to firmly fix the second fixing boss 52 to the bottom wall 11b of the ECU housing 11.

Since the lower end of the first fixing boss 51 is upwardly pushed by the welding device during the above-described welding process, the bobbin 22b is upwardly moved by a certain distance. As a result, the upper end of the bobbin 22b comes into close contact with the upper case 22c.

When the jig, which continuously pushes the bottom wall 11b of the ECU housing 11, is subsequently released, the elastic support member 60 returns to its original state, thereby upwardly moving the cases 22c and 22d by a certain distance.

As a result, a certain gap is formed between the top of the bobbin 22b and the upper case 22c. The cases 22c and 22d are restrained from moving vertically. Accordingly, it is possible to prevent the resistance of the coil 22a in the bobbin 22b from being varied due to the weight of the upper case 22c. Since upward movement of the cases 22c and 22d is restrained, magnetic flux passing through the cases 22c and 22d is constant.

Thereafter, the hydraulic block 30 is positioned on the top of the ECU housing 11 in a vertically aligned state such that the sleeve 21a of the valve assembly 21 is inserted into the coil assembly 22. The hydraulic block 30 is then fastened to the ECU housing 11, using mounting bolts (not shown), so that the hydraulic block 30 and ECU housing 11 are firmly coupled.

As apparent from the above description, in accordance with the fixing device for the coil assembly of the solenoid valve for the electronically controlled brake system according to the present invention, the bobbin is firmly coupled to the ECU housing by the fixing bosses provided at the bottom of the bobbin and the fixing grooves formed at the bottom of the ECU housing to receive the fixing bosses, and the cases enclosing the bobbin are elastically supported by the elastic support member. Accordingly, the bobbin and cases can be easily and firmly fixed to the ECU housing.

Therefore, the assemblability of the coil assembly is improved. Also, there is an advantage in that the manufacturing costs of the electronically controlled brake system are reduced.

In accordance with the present invention, it is also possible to restrain vertical movement of the cases while maintaining a certain gap between the bobbin and the upper case. Accordingly, magnetic flux passing through the cases is constant. Also, it is possible to prevent the resistance of the coil wound around the bobbin from being varied due to the weight of the upper case.

Therefore, there is no deviation in the performance of the solenoid valve, so that it is possible to precisely control the solenoid valve.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. In an electronically controlled brake system comprising an electric control unit (ECU) housing, and a plurality of solenoid valves each comprising a valve assembly including a sleeve and an armature slidably received in the sleeve, a coil assembly including a bobbin to axially receive the sleeve of the valve assembly and a coil wound around the bobbin, a case to receive the bobbin, the case being axially spaced from a top of the bobbin to define a predetermined gap, leads fixed to the bobbin in an inserted manner to be electrically connected to a circuit board arranged in the ECU housing, and a fixing device to fix the coil assembly to the ECU housing, the coil assemblies of the solenoid valves being arranged in the ECU housing while being uniformly spaced apart from one another, the fixing device comprising:
fixing bosses axially protruded from a bottom of the bobbin to extend axially through the case;
fixing grooves formed at a bottom wall of the ECU housing to receive protruded ends of the fixing bosses, and thus, to fix the fixing bosses, respectively; and
an elastic support member provided at the bottom wall of the ECU housing to elastically support a bottom of the case.

2. The fixing device according to claim 1, wherein the elastic support member is fixed to the bottom wall of the ECU housing at one end, and is free at the other end.

3. The fixing member according to claim 2, wherein the elastic support member is provided with a protrusion protruded from an upper surface of the free end of the elastic member to support the case.

4. The fixing member according to claim 3, wherein the free end and the protrusion have arc shapes to stably elastically support the bottom of the case, respectively.

5. The fixing member according to claim 3, wherein the elastic support member has a structure having a width gradually reduced toward the free end so that the elastic support member does not interfere with the fixing grooves.
